(19) United States
(12) Patent Application Publication
(10) Pub. No.: US 2019/0278880 A1
(43) Pub. Date: Sep. 12, 2019

(54) HYBRID COMPUTATIONAL MATERIALS FABRICATION

(71) Applicant: ExxonMobil Research and Engineering Company, Annandale, NJ (US)

(72) Inventors: Ning Ma, Whitehouse Station, NJ (US); Niranjan A. Subrahmanya, Mountain View, CA (US); Wei D. Liu, Schenectady, NY (US); Sumathy Raman, Annandale, NJ (US)

(21) Appl. No.: 16/295,004

(22) Filed: Mar. 7, 2019

Related U.S. Application Data
(60) Provisional application No. 62/641,550, filed on Mar. 12, 2018.

(51) Int. Cl. G06F 17/50; G06N 3/08; G06N 20/00

(52) U.S. Cl. CPC G06F 17/5009; G06N 20/00; G06N 3/08

(57) ABSTRACT

This disclosure generally relates to a methodology of effectively designing and/or discovering new materials based on microstructure, and more particularly, to designing and/or discovering new materials by combining material fundamentals and experimental data. The methodology disclosed herein provides cost-effective and time-effective solutions for material design that combine the benefits of both of the two major computational material design approaches: physics-based and data-driven computer models.

### CROSS-REFERENCE TO RELATED APPLICATIONS

This application claims priority to U.S. Provisional Application No. 62/641,550 filed Mar. 12, 2018, which is herein incorporated by reference in its entirety.

### FIELD OF THE INVENTION

The disclosed embodiments generally relate to a methodology of effectively designing and/or discovering new materials based on microstructure, and more particularly, to designing/discovering new materials by combining material fundamentals and experimental data.

### BACKGROUND

Although materials fabrication such as metals, polymer and ceramics has long been known, it is a relatively new discovery that both physical and chemical properties of a given material might not be primarily controlled by its composition but rather by its microstructures. Materials microstructures are structural features that are identified under a microscopy. These features include phases and defects characterized by their amount, size, shape, and spatial arrangement. These structural features usually have an intermediate mesoscopic length scale in the range of less than 1 nm to 100 μm.

Materials microstructure can be manipulated through either composition or processing modification. Since processing modification is relatively inexpensive, many currently known techniques optimize microstructure for desired evolution of properties using advanced processing. However, current ability to quantitatively predict microstructural evolution under processing, (for e.g., thermal or mechanical) and hence ability to boost the performance of the material is rather limited because of the extreme complexity of microstructure and the nonlinear interaction of its individual elements or subsets of elements. In current industrial practice trial and error process typically allows creation of new materials. Alternatively, rendered by the development of high performance computing algorithms, computational material design is becoming an attractive and viable option to discover or advance development of new materials in an accelerated phase.

There are two major computational material design approaches: physics based and data-driven computer models. To provide solutions for material design in a cost-effective and time-effective way there is a need in the art for combining the benefits of both physics and data-driven approaches.

### SUMMARY

Certain aspects of the present disclosure relate to designing and discovering new materials.

In accordance with a purpose of the illustrated embodiments, in one aspect, a method for designing and discovering new materials includes providing a hybrid computing model. The hybrid computing model is trained using a plurality of microstructure images, property data, and materials fundamentals data and using basic correlation information between composition and the processing data, microstructure and the property data and computationally synthesized material data. Comprehensive correlation between the composition and the processing data, generated quantitative microstructure data and the property data is generated by the hybrid computing model. A material design solution satisfying one or more predefined constraint conditions is generated based on the generated comprehensive correlation.

### BRIEF DESCRIPTION OF THE DRAWINGS

The present disclosure will become more fully understood from the detailed description and the accompanying drawings. These accompanying drawings illustrate one or more embodiments of the present disclosure and, together with the written description, serve to explain the principles of the present disclosure. Wherever possible, the same reference numbers are used throughout the drawings to refer to the same or like elements of an embodiment.

FIG. 1 illustrates components of a materials design framework that might be used to design and/or discover new materials based on microstructure, according to an embodiment of the present invention.

FIG. 2 is a block diagram of an exemplary hybrid model of FIG. 1 for correlating composition and processing data, microstructure data and property data, according to an embodiment of the present invention.

FIG. 3 is a diagram illustrating a learning model applied to microstructure image analysis, according to an embodiment of the present invention.

FIG. 4 is a schematic diagram of exemplary convolutional neural network model architecture, according to an embodiment of the present invention.

FIG. 5 is a label map demonstrating the performance of the machine learning method utilizing clustering algorithm, according to an embodiment of the present invention.

FIG. 6 illustrates an exemplary neural network training workflow that includes pre-training using annotated microscopy dataset, according to an embodiment of the present invention.

FIG. 7 illustrates a physics based microstructure evolution model that may be utilized by embodiments of the present invention.

### DESCRIPTION OF CERTAIN EMBODIMENTS

The illustrated embodiments are not limited in any way to what is illustrated as the illustrated embodiments described below are merely exemplary, which can be embodied in various forms, as appreciated by one skilled in the art. Therefore, it is to be understood that any structural and functional details disclosed herein are not to be interpreted as limiting, but merely as a basis for the claims and as a representation for teaching one skilled in the art to variously employ the discussed embodiments. Furthermore, the terms and phrases used herein are not intended to be limiting but rather to provide an understandable description of the illustrated embodiments.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the illustrated embodiments, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the illustrated embodiments discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the illustrated embodiments based on the above-described embodiments. Accordingly, the illustrated embodiments are not to be limited by what has been particularly shown and described, except as indicated by the appended claims.

In exemplary embodiments, a computer system component may constitute a “module” that is configured and operates to perform certain operations as described herein below. Accordingly, the term “module” should be understood to encompass a tangible entity, be that an entity that is physically constructed, permanently configured (e.g., hardwired) or temporarily configured (e.g. programmed) to operate in a certain manner and to perform certain operations described herein.

As noted above, there are two major computational material design approaches: physics based and data-driven computer models. Physics based models describe a large class of observations with few arbitrary parameters and make predictions which can be verified or disproved. Because the discipline of material design is so broad, and because the materials it describes tend to have complex microstructure evolution, the physics based microstructure-property models associated with the discipline also tend to be complex. To manage this complexity, unrealistic simplifications have to be made in such models based on the physics of various materials.

In contrast, data-driven approaches are extremely flexible and hence will reveal patterns and new phenomena even previously unknown in science. The challenges with data-driven approaches include generating a large number of high quality training data, in particular, when microstructure characterization is involved. In addition, the reliability of the data-driven models is not established when extrapolated beyond the domain of the training dataset, even if large datasets are used for training purposes. To overcome the aforementioned limits, embodiments the present invention combine the benefits of both physics and data-driven approaches to provide solutions for material design in a cost-effective and time-efficient manner.

Various embodiments of the present invention are directed to a novel computational framework for material design optimization that supports fast and effective materials discovery and/or developments. At least in some embodiments machine learning/computer vision can be used to automatically provide high quality material data including quantitative microstructure information. This description presents a set of hybrid physics and data-driven modeling tools that can be employed to yield unambiguous composition and processing-microstructure-property relationship. At least in some embodiments, an optimizer can be used to solve inverse problems. In one embodiment, an integrated inverse problem is solved with modern optimization methods employed by an optimizer, while preserving the modularity of the material design stage. Various embodiments of the present application may be utilized in a broad range of designed materials including, but not limited to, steels, super-alloys, polymers, semi-conductors and ceramics for enhancement of various mechanical properties, optical properties, thermal stabilities, and other properties.

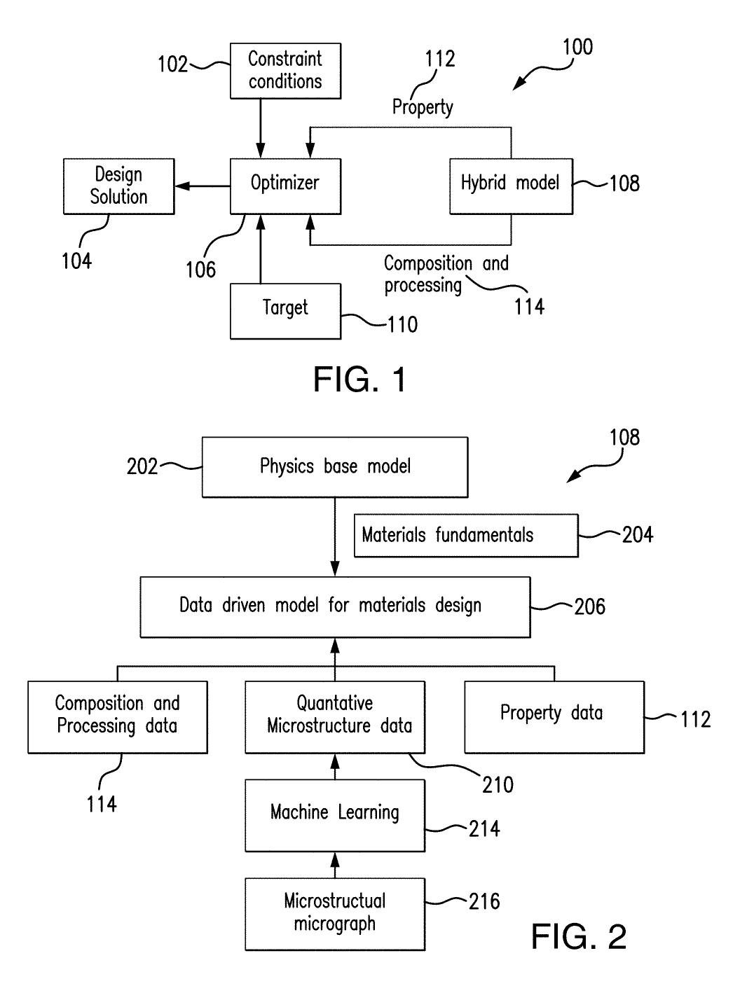

FIG. 1 illustrates components of a materials design computational framework that might be used to design and/or discover new materials based on microstructure, according to an embodiment of the present invention. It is noted that the framework of FIG. 1 is merely one example of a possible materials design framework, and embodiments may be implemented in any of various materials design computational frameworks, as desired.

As shown, the exemplary computational framework 100 includes an optimizer module 106 configured to run a hybrid computational model 108 in order to find and ensure design solutions 104 for targeted properties 110 under constraint conditions 102. In various embodiments, constraint conditions 102 may include various design objectives, design constraints, boundary conditions, and other design criteria. At least one advantage of the disclosed approach is that it allows an end-user to review and verify an approximate rendering of potential material design solutions 104 before causing a computationally intensive, and possibly expensive, rendering of material design solutions to take place.

According to an embodiment of the present invention, the optimizer module 106 is configured to solve one or more inverse problems to solve an optimization problem. The optimizer module 106 is a functional approximation that maps the material property back to the experimental conditions that potentially generate materials with the target property. The actual approximation function can be any multivariate mappings such as neural networks or Gaussian process. The hybrid model 108 is configured to correlate composition and processing data 114, quantitative microstructure data 210 (shown in FIG. 2) and property data 112. The hybrid model 108 is configured to transmit the property data 112 and composition and processing data 114 to the optimizer module 106. Targeted properties 110 in a target material and the constraint conditions 102 comprise additional input into the optimizer module 106. It should be noted that the property data 112 may include but are not limited to thermal-physical properties, mechanical properties and corrosion resistant properties. Examples of thermal-physical properties include, but are not limited to, density, thermal conductivity, latent heat, specific heat or the like. Examples of mechanical properties include, but are not limited to, tensile and fatigue (e.g. of cast aluminum alloys) on both global uniform and local multi-scale defect and microstructure basis. Examples of corrosion resistant properties include, but are not limited to, corrosion rate under sweet/sour condition, pitting corrosion potential, stress crack corrosion and sulfur stress crack properties. Composition and processing data 114 may include, but is not limited to, chemical composition data.

Again, the optimizer module 106 is configured to run the hybrid computational model 108 in order to find and ensure design solutions 104 for targeted properties 110 under constraint conditions 102. For, instance, the optimizer module 106 may be asked to minimize raw material cost or provide energy yield optimization, while minimizing production energy, carbon footprint and to maximize sales cash flow and resulting investment return.

FIG. 2 is a block diagram of an exemplary hybrid model of FIG. 1 for correlating composition and processing data, microstructure data and property data, according to an embodiment of the present invention. In this embodiment, the hybrid model 108 is configured to correlate the composition and processing data 114, quantitative microstructure data 210 and property data 112 through proper combination of physics and data driven computing approaches.

The physics based model 202 describes microstructure evolution and provides material property prediction with few fitting parameters. In some embodiments, the physics based model 202 may include a multi-scale modeling infrastructure (e.g., length and time scales) which is user-friendly and is validated against analytical solutions, state-of-the art finite element solutions and experiments. In the embodiment illustrated in FIG. 2, the physics based model 202 is configured to feed the materials fundamentals data 204 to a data driven model for materials design 206. The materials fundamentals data 204 may include basic physical relationship between composition and processing, microstructure and property and/or computationally synthesized microstructure images and property data. In various embodiments, the physics based model 202 may either populate the material fundamentals data 204 with synthetic data from its model or adoptively optimize the functional dependence of variables in the data-driven model 206 using one or more known patterns.

The data-driven model 206 is configured to find complex correlation of composition and processing data 114, quantitative microstructure data 210 and property data 112 based on large amount of digital experimental data. At least in some embodiments, the data-driven model 206 is capable of handling sparse data source (e.g., one or more databases) where some composition and processing, microstructure and property data are missing. Examples of the composition and processing data 114 and the property data 112 are discussed above in conjunction with FIG. 1.

According to an embodiment of the present invention, the quantitative microstructure data parameters 210 are generated by the hybrid model 108 using a set of microstructural micrographs 216 by applying modern machine learning methods 214, for example, employing neural networks framework. The set of micrographs 216 depicts microstructures of various materials. In one embodiment, a microstructural micrograph 216 may comprise microstructure taken at 250× magnification. As described in greater detail below, the applied modern machine learning methods 214 are capable of consistently and autonomously performing high-throughput microstructural constitute segmentation of given microstructural micrographs 216. Furthermore, the applied machine learning methods 214 are configured to extract from the microstructural micrographs 216 a variety of quantitative microstructure information, including but not limited to, the volume fraction, size, shape and spatial distribution of phases and defects.

The advantages of the hybrid model 108 contemplated by various embodiments of the present invention include the combination of prediction reliability rendered by materials fundamental data provided by the physics based model 202 and capability of consistently revealing complex patterns in materials microstructure data and identifying new microstructures or phases that were either unknown or missed by human eye by applying modern machine learning methods 214. In one illustrative embodiment, these machine learning methods 214 translate the definition of a machine learning problem into a neural network structure for solving the problem. In addition, the machine learning methods 214 can mitigate uncertainty of microstructure input. Once the hybrid model 108 is developed for certain materials system, little computational power is required for automating particular computational based materials design and the developed algorithm can be applied to broader material systems.

A key step provided by the hybrid model 108 for material design is the ability to automatically adjust model parameters based on characterized images (micrographs) of microstructures 216 in a quantitative fashion. Various embodiments of the present invention are directed to a novel deep learning focused microstructure recognition and characterization method so that recognition of various materials is possible with microstructure alone. The method disclosed below should be considered as one non-limiting example of a method employing deep convolutional neural networks for microstructure characterization. Disclosed herein are a method and system for training the hybrid model 108 to work with limited or not labeled data. Other possible frameworks to be used for microstructure characterization when a larger amount of annotated data is available typically utilize pixel-wise segmentation in a supervised setting. Examples of such known methods/frameworks include, but are not limited to Fully Convolutional Networks (FCN), U-Net, pix2pix and their extensions. However, the framework of FCNs used for semantic image segmentation and other tasks such as super-resolution is not as deep as disclosed method's. For example, FCN network may accept an image as the input and produce an entire image as the output through four hidden layers of convolutional filters. The weights are learned by minimizing the difference between the output and the clean image.

One challenge of applying deep learning methods to microstructure image analysis is the lack of large size, annotated data for training the neural network models. However, humans are capable of using their vision system to recognize both the patterns from everyday natural images and the patterns from microscopic images. Therefore, at the very high level, the goal is to train the model with natural images and teach them to automatically learn data patterns that can be used for microstructure recognition tasks. Advantageously, based on an understanding of natural microstructure images, the models are capable of identifying key points within similar microstructures. Embodiments of the present invention utilize a concept known as transfer learning in machine learning community. In other words, the disclosed methods utilize effective automatic retention and transfer of knowledge from one task (natural images) to another related task (microstructure image analysis).

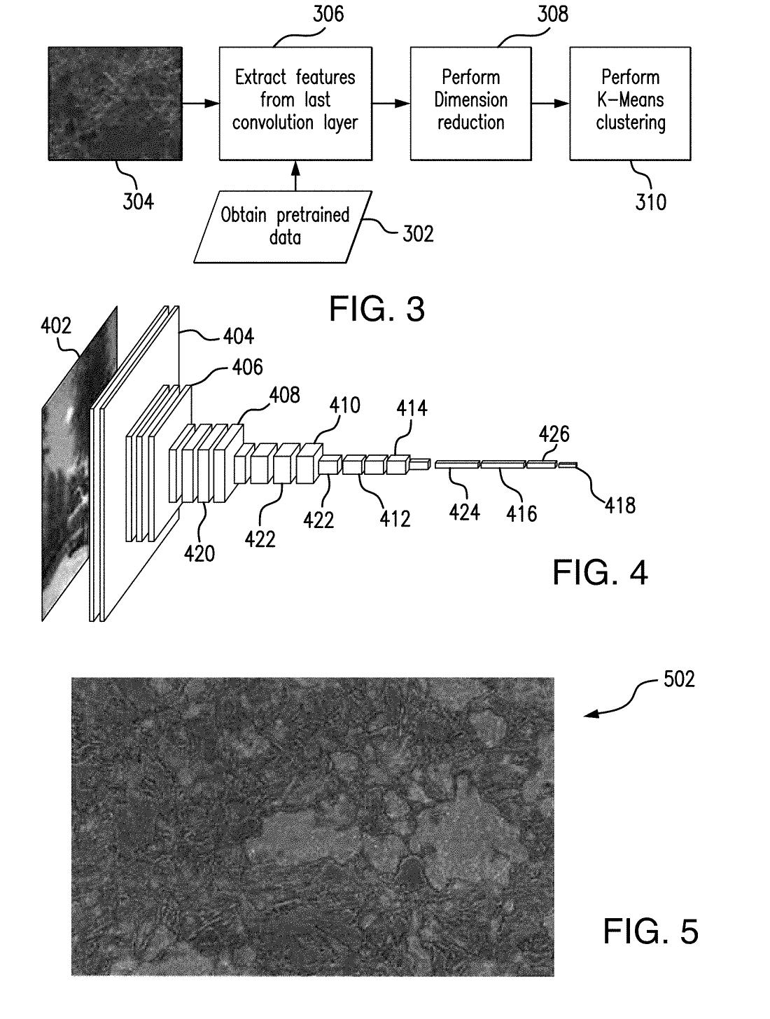

FIG. 3 is a diagram illustrating a learning model applied to microstructure image analysis, according to an embodiment of the present invention. Comprehensive image understanding typically requires more than single object classification. A deep learning model is provided to efficiently detect features from an image (e.g., a microstructure image). In one embodiment of the disclosed technology, the machine learning method 214 (shown in FIG. 2) includes training a convolutional neural network (CNN) with a series of reference images using ImageNet dataset. Automatic image understanding can be substantially improved with the use of improved databases (e.g., an ImageNet database) and neural networks (e.g., deep CNNs), facilitating effective learning to recognize the images with a large pool of hierarchical representations. According to an embodiment of the present invention, the pre-trained CNN model is used as a feature extractor. This pre-trained CNN model applies unsupervised learning algorithm to the extracted features, as a way of exploring the capability of a transferred model.

In one embodiment described herein, at step 302, the machine learning method 214 may use pre-trained CNN method to alleviate the learning requirement. However, the method can incorporate both pre-trained and non-pre-trained CNN methods, depending on the availability of labeled training data that can attain sufficient feature learning. One CNN method known as OverFeat, for example, allows the use of deep learning out-of-the-box when limited training data sets are available. In such example, the deep features are pre-trained using a dataset of natural images (e.g., a set of 1.2 million natural images in the ImageNet database).

The pre-trained data can include ImageNet images stored in a CNN in a plurality of levels and/or layers (see FIG. 4). The plurality of layers, such as, but not limited to convolution layer, fully connected layer, max pooling layer, and the like can correspond to domain features of the predetermined domain (e.g., feature detection, etc.). As such, each layer of the CNN comprises an output representative of a feature of the object image to be classified 304. In one embodiment, the trained CNN may include 19 layers. As shown in FIG. 3, the pre-trained data 302 and the object image to be classified 304 are inputs into step 306. At step, 306, the machine learning method 214 automatically extracts a set of deep features from the pre-trained CNN 302 for each pixel of the image 304. In the illustrated example, the output of the 19th layer (the last convolutional layer) of the pre-trained CNN (e.g. OverFeat) can be used as the deep learning features.

Next, the machine learning method 214 applies unsupervised learning algorithm to the extracted features, as a way of exploring the capability of transferred model. At step 308, Principal Component Analysis (PCA), whitening or another dimensionality reducing technique is applied to project the high order features into a lower dimensional space, preferably with low inter-dimensional correlations as is provided by PCA. This corresponds to unsupervised learning operation of the machine learning method 214. In other words, PCA or another dimensionality reducing technique is used to remove the redundant information from the high dimension features in order to obtain a lower dimensional feature set. For example, if about 1000 deep features are extracted at step 306 by the machine learning method 214, the dimensionality reducing step 308 may reduce that number to about 50 features.

At step 310, clustering is performed on input image slices. In one example, K-means clustering is performed on low-level features of the pixels with the number of clusters N specified as N=3, for example. According to this example, clustering includes application of K-means clustering on low-level features for each image slice. Generally, K-means clustering aims to partition observations into N clusters in which each observation belongs to the cluster with the nearest mean (or “center”), serving as a prototype of the cluster. It should be understood that various types of low-level features could be used. Moreover, other clustering methods could be used. For example, clustering step 310 can be performed by using an algorithm selected from a group, including, but not limited to, K-means and Gaussian Mixture Models. In addition, N can also be varied.

FIG. 4 is a schematic diagram of exemplary convolutional neural network model architecture, according to an embodiment of the present invention. The architecture in FIG. 4 shows a plurality of feature maps, also known as activation maps. In one illustrative example, if the object image to be classified 402 is a JPEG image having size of 224×224, the representative array of that image will be 224×224×3 (The 3 refers to RGB values). The corresponding feature maps 404-418 can be represented by the following arrays 224×224×64, 112×112×128, 56×56×256, 28×28×512, 14×14×512, 7×7×512, 1×1×4096, 1×1×1000, respectively.

Moreover, as noted above, the convolutional neural network includes multiple layers, one of which is a convolution layer that performs a convolution, for each of one or more filters in the convolution layer, of the filter over the input data. At a high level, CNN takes the image 402, and passes it through a series of convolutional, nonlinear, pooling (downsampling), and fully connected layers to get an output. The output can be a single class or a probability of classes that best describes the image.

The convolution includes generation of an inner product based on the filter and the input data. After each convolution layer, it is conventional technique to apply a nonlinear layer (or activation layer) immediately afterward such as ReLU (Rectified Linear Units) layer. The purpose of this layer is to introduce nonlinearity to a system that basically has just been computing linear operations during the convolution layers (just element wise multiplications and summations). After some ReLU layers, CNN may have one or more pooling layers. They are also referred to as downsampling layers. In this category, there are also several layer options, with maxpooling being the most popular. This layer basically takes a filter (normally of size 2×2) and a stride of the same length. It then applies it to the input volume and outputs the maximum number in every sub-region that the filter convolves around.

The fully connected layer takes an input volume (whatever the output is of the cony or ReLU or pool layer preceding it) and outputs an N dimensional vector where N is the number of classes that the learning model has to choose from. Each number in this N dimensional vector represents the probability of a certain class. The way this fully connected layer works is that it looks at the output of the previous layer (which represents the activation maps of high level features) and determines which features most correlate to a particular class. For example, a particular output feature from previous convolution layer may indicate if a specific location in the image is a human's eye, and such feature can be used to classify ‘human’ or ‘non-human’ for a target image. Furthermore, the exemplary CNN architecture has a softmax layer along with a final fully connected layer to explicitly model bipartite-graph labels (BGLs), which can be used to optimize the CNN with global back-propagation.

More specifically, the exemplary architecture of the CNN network shown in FIG. 4 includes a plurality of convolution+ReLU layers 420, max pooling layers 422, fully connected+ReLU layers 424 and the softmax layer 426.

FIG. 5 is a label map 502 demonstrating the performance of the clustering algorithm, according to an embodiment of the present invention. At least in some embodiments the hybrid model 108 may use looped deep image feature clustering (e.g., to refine image labels) and deep CNN training/classification (e.g., to obtain more task representative deep features using new labels). In certain examples, a method provides convergence of better labels leading to better-trained CNN models which consequently feed more effective deep image features to facilitate more meaningful clustering/labels. FIG. 5 shows the K-Means clustering results on the PCA processed image features extracted from the pre-trained CNN network. Note that in the illustrated example the CNN model is pre-trained 302 on natural images, which are fundamentally different from Scanning Electron Microscope (SEM) microstructure images. FIG. 5 illustrates that considering the difference between the two image modalities (natural images and SEM images), the segmentation map derived using the clustering process described herein matches the underlying phase patterns surprisingly well.

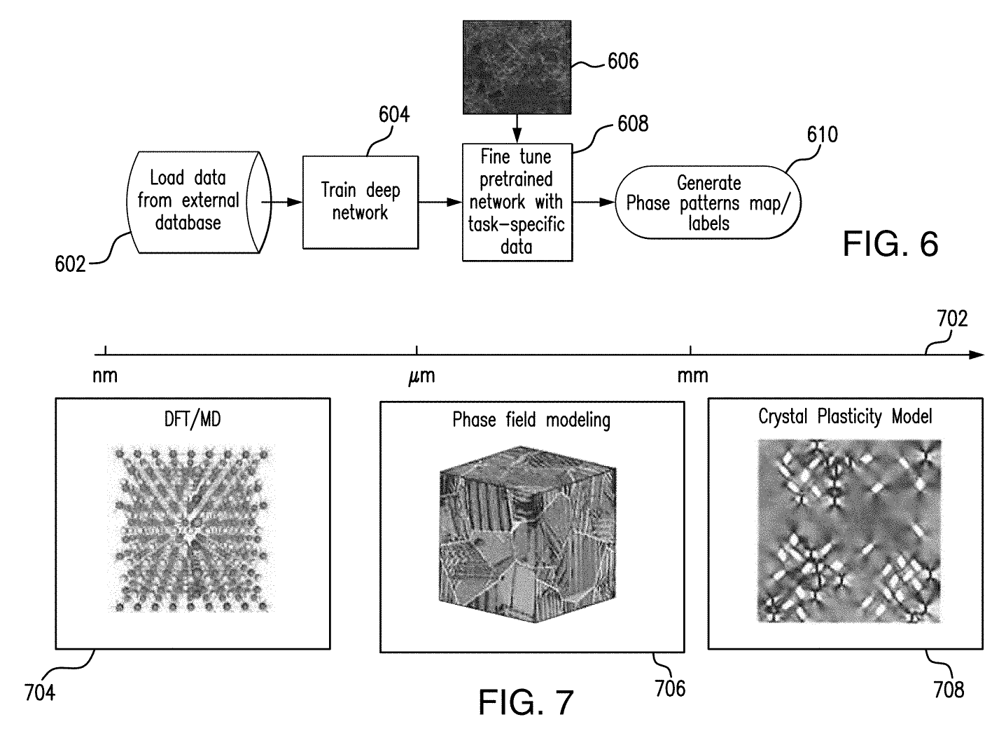

Although the unsupervised learning model described above can generate phase map that matches the true phase patterns, the model does not have information about the microstructure phases. FIG. 6 illustrates an exemplary neural network training workflow that includes pre-training using annotated microscopy dataset, according to an embodiment of the present invention.

The CNN learning model described above is pre-trained 302 with natural images, which are drastically different from microscopy images of various materials. In the alternative embodiment shown in FIG. 6, an annotated microscopy dataset is also used for pre-training purposes. In this embodiment, the learning model is constructed by training with one or more external datasets. The parameters of the pre-trained learning model are fine-tuned using annotated, problem specific dataset of microscopic images, so that it also represents well the microscopic image inputs. In this training session, a novel form of problem specific dataset is used to improve performance.

As shown in FIG. 6, training data is loaded from an external database at step 602. In one non-limiting example such a dataset may comprise a plurality of high carbon steel SEM images. At step 604, the hybrid model 108 further trains the Image-Net trained deep CNN using the dataset loaded in step 602. At step, 608, the hybrid model 108 fine tunes pre-trained network with task-specific data 606. As a result of this fine-tuning process, at step 610, the hybrid model 108 generates phase pattern map/labels illustrated in FIG. 5.

FIG. 7 illustrates a physics based microstructure evolution model that may be utilized by embodiments of the present invention. Generally, microstructure evolution describes thermodynamically unstable feature continuing to evolve with time. The driving force for the temporal evolution of a microstructure usually consists of one or one of the following: a reduction in bulk-chemical free energy, a decrease of the total interfacial energy between different phases or between different orientation domains, relaxation of the elastic-strain energy generated by lattice mismatch between different phases (e.g. strain relaxation at the interface between a ultra-thin silicon device layer and a dielectric layer), external driving forces such as temperature, time varying electric and magnetic fields, electromagnetic waves, pressure, sound, stress, etc.

The kinetics of microstructure evolution is governed by long range atomistic transportation across the entire domain of phases and short range repositioning of atoms across interfaces. Embodiments of the present invention contemplate a multi-scale microstructure evolution model (e.g., nano, micro, macro scales) to handle the hierarchical problem. FIG. 7 illustrates a physics based microstructure evolution model that may be utilized by embodiments of the present invention. FIG. 7 uncovers the elusive connections in the hierarchy of Density Functional Theory (DFT)/molecular dynamics model 704 (nanometer scale), phase field model 706 (micrometer scale) and crystal plasticity model 708 (macroscopic scale). DFT modeling level 704 typically represents a small part of a material, considering each atom separately and how the atoms are connected to each other. FIG. 7 further illustrates a three-dimensional microscopic phase field model 706. The microscopic phase field model 706 provides information about microstructure evolution and about interface properties received from atomistic modeling. The crystal plasticity finite element modeling (CPFEM) 708 is also known to those skilled in the art. It is appreciated that the CPFEM includes a finite element model (FEM) of a uniaxial loading test sample, e.g. a tensile sample. This model provides information about mechanical properties of a particular material upon deformation with explicitly considering the material microstructure. According to embodiments of the present invention, results from simulations at the smaller length scale may be fed into larger length scale models.

In summary, various embodiments of the present invention are directed to a novel computational framework for material design optimization that supports fast and effective materials discovery and/or developments. Advantageously, the novel computational framework is configured to utilize two major computational material design approaches: physics based and data-driven computer models. The advantages of the hybrid model 108 contemplated by various embodiments of the present invention include the combination of prediction reliability rendered provided by the physics based model 202 and capability of revealing complex correlation in materials data by applying data driven model 206. Furthermore, a key step provided by the disclosed computational framework for material design is the ability to automatically recognize complex pattern of characterized images (micrographs) of microstructures 216 in a quantitative fashion using modern machine learning methods 214.

With certain illustrated embodiments described above, it is to be appreciated that various non-limiting embodiments described herein may be used separately, combined or selectively combined for specific applications. Further, some of the various features of the above non-limiting embodiments may be used without the corresponding use of other described features. The foregoing description should therefore be considered as merely illustrative of the principles, teachings and exemplary embodiments of this invention, and not in limitation thereof.

It is to be understood that the above-described arrangements are only illustrative of the application of the principles of the illustrated embodiments. Numerous modifications and alternative arrangements may be devised by those skilled in the art without departing from the scope of the illustrated embodiments, and the appended claims are intended to cover such modifications and arrangements.

1. A method for designing and discovering new materials, the method comprising:
providing a hybrid computing model comprising a physics based model and a data driven model;
training the hybrid computing model using a plurality of microstructure images, property data, and materials fundamentals data and using basic correlation information between composition and the processing data, microstructure and the property data and computationally synthesized material data;
generating, by the hybrid computing model, comprehensive correlation between the composition and the processing data, generated quantitative microstructure data and the property data; and
generating a material design solution satisfying one or more predefined constraint conditions based on the generated comprehensive correlation.

2. The method of claim 1, wherein the one or more constraint conditions comprise at least one of one or more design objectives, one or more design constraints, one or more boundary conditions.

3. The method of claim 1, wherein the plurality of reference images is stored in an image database.

4. The method of claim 1, wherein the quantitative microstructure data is generated using machining learning comprising a trained convolutional neural network (CNN).

5. The method of claim 3, wherein the plurality of reference images comprises a plurality of natural images and wherein the one or more images of microstructure comprise one or more Scanning Electron Microscope (SEM) microstructure images.

6. The method of claim 4, wherein the CNN comprises a plurality of feature maps.

7. The method of claim 4, wherein the CNN comprises at least some of one or more convolution layers, one or more ReLU (Rectified Linear Units) layers, one or more max pooling layers, one or more fully connected layers and one or more softmax layers.

8. The system of claim 1, wherein the step of correlating data further comprises fine tuning the trained hybrid computing model with task-specific data.
